(19) United States
(12) Patent Application Publication
(10) Pub. No.: US 2004/0105546 A1
(43) Pub. Date: Jun. 3, 2004

(54) Geometry-Based Symmetric Cryptosystem Method

(76) Inventors: Leon Chernyak, Brighton, MA (US); Arkady Berenstein, Eugene, OR (US)

Correspondence Address: LEON CHERNYAK, 112 ACADEMY HILL RD. #1, BRIGHTON, MA, 02135, US

(21) Appl. No.: 10/605,935

(22) Filed: Nov. 6, 2003

Related U.S. Application Data
(63) Continuation of application No. 60/319,710, filed on Nov. 19, 2002.

(51) Int. Cl. H04L 9/00

(52) U.S. Cl. 380/259

(57) ABSTRACT

A method of communicating information between users of a communication system includes the following steps of: generating a module V over a ring R; generating an outer component P of encryption key that includes sequence (p₁, p₂, . . . , pₖ) where each member pⱼ of the sequence belongs to the set {1, 2, . . . , m} (the length k of the sequence is arbitrary and thus repetitions are allowed in the sequence); generating an inner component Q of encryption key that includes elements v_{1,}v₂, . . . , Vₘ of V and automorphisms g₁, g₂, . . . , gₘ of V; generating the encryption key K=(P; Q), where P is the outer component and Q is the inner component; generating an encryption automorphism Tₑ of V based on the encryption key K, where Tₑ includes a composition of certain automorphisms T₁, T₂, . . . , Tₘ of the module V which composition is performed in the order prescribed by P; generating an encrypted message element E as a function of a message element M in V and of the encryption automorphism Tₑ; transmitting the encrypted message element E along with the outer component P from one user to another; generating the outer component P′ of the decryption key that includes sequence (pₖ, pₖ₋₁, . . . , p₁), i.e., the sequence reversed of that involved in producing the outer component P of the encryption key; generating the decryption key K′=(P′; Q′), where P′ is the outer component of the decryption key and Q′ is the inner component of the decryption key which is equal to the inner component Q of the encryption key; generating a decryption automorphism T_{d} of V based on the decryption key K′, where T_{d} includes a composition of the automorphisms T₁, T₂, . . . , Tₘ, which composition is performed in the order prescribed by P′, e.g., T_{d} is the inverse automorphism of Tₑ; determining the message element M as a function of the encrypted message element E and of the decryption automorphism T_{d}, where the function is the same as that one used in generation of E (that is, the decryption method is symmetric to encryption: the decryption proceeds as the encryption, but with replacement of the outer component P with the outer component P′).

### CROSS REFERENCE TO RELATED APPLICATIONS

U.S. Pat. No. 5,740,250, April 1998, by Moh; U.S. Pat. No. 6,038,317, March 2000, by Magliveras et al; U.S. Pat. No. 6,298,137, October 2001, by Hoffstein et al; U.S. Provisional Patent Application No. 60/319,710, filed November 2002, by Berenstein and Chernyak.

### COPYRIGHT STATEMENT

This application claims priority from U.S. Provisional Patent Application No. 60/319,710, filed Nov. 19, 2002, and said Provisional Patent Application is incorporated herein by reference.

### BACKGROUND OF INVENTION

Secure exchange of data between two parties, for example, between two computers, requires encryption. There are two general methods of encryption in use today, private key encryption and public key encryption. A public key cryptosystem is one in which each party can publish their encryption process without compromising the security of the decryption process. The encryption process is popularly called a “trap-door” function. The public key cryptosystems are typically used for transmitting small amounts of data, such as credit card numbers, and they are also used to transmit a private key which is then used for private key encryption. Public key cryptosystems are generally slower than private key cryptosystems. Most of known public key cryptosystems have been recently broken using high computational power. In private key encryption, the two parties privately exchange the keys to be used for encryption and decryption. A widely used example of a private key cryptosystem is DES, the Data Encryption Standard. Such systems can be fast and secure, but they suffer the disadvantage that the two parties must exchange their keys privately. This problem is currently addressed by using of public key cryptosystems for private key distribution/sharing. The most famous key sharing method currently used is Diffie-Hellman protocol. However, in the situation when the same private key is used very frequently, especially in the case of large communication networks of trusted participants, the private key is vulnerable to attacks. Therefore, there is a necessity of the periodic change of the private keys. This later disadvantage amplifies the former disadvantage of the systems due to the necessity of synchronizing private keys among the participants of the communication network and thus may cause serious inconvenience for the participants. Most users, therefore, would find it desirable to have a cryptosystem which combines advantages of the private and public ones: relatively short, easily created keys with relatively high speed encryption and decryption processes, secure generation and/or distribution of private keys. In other words, the desirable solution has to be a synthesis of public and private cryptosystems.

It is among the objects of the invention to provide a cryptosystem with elements of public and private cryptosystems. In this cryptosystem both the encryption and decryption keys are composed out of non-secret outer component and a secret inner components in such a way that both components of the keys are relatively short and easily generated, and the encryption and decryption processes can be performed extremely rapidly.

It is also among the objects hereof to provide a cryptosystem which has very low memory requirements and which depends on a variety of internal parameters that permit substantial flexibility in balancing security level, key length, encryption and decryption speed, memory requirements, and bandwidth. It is also among the objects of the invention to provide the cryptosystem capability for generating encryption/decryption transformations based both on the outer components of the keys and on cryptosystem's internal parameters so that knowledge of the outer components of the keys does not provide a slightest possibility for reconstruction of the inner components of the keys.

### SUMMARY OF INVENTION

The symmetric encryption system of the present invention has short and easily created encryption/decryption keys and wherein the encryption and decryption processes are performed extremely rapidly, and has very low computer memory requirements. The encryption and decryption processes use the operations of addition and dot product of vectors in vector spaces over the field of real numbers or, more generally, over any ring. The cryptosystem of the present invention constructs encryption/decryption keys on the fly out of a chosen set of vectors of a given vector space or, more generally, of a module over a given ring. Total length of the chosen vectors is comparable to or much shorter than the key lengths of the most widely used prior art cryptosystems. The present invention, while requiring extremely little computer memory (about 128 bits for the inner component of the encryption/decryption key), features an extremely high security level (at least 2¹⁷⁸), with encryption and decryption processes ranging from approximately two to three orders of magnitude faster than the prior art. Each encryption/decryption key of the cryptosystem hereof consists of an outer component and an inner component. The role of the outer component is played by a set of discrete data that, typically, is a finite sequence of positive integers. The role of the inner component (which also further referred to as “internal parameters”) is played by continuous data. In one embodiment the internal parameters include a set of vectors of a given vector space. In another embodiment these parameters include, besides a set of vectors of a given vector space, a set of polynomial or rational automorphisms of this vector space. The encryption and decryption techniques are mutually symmetric and require the same time, amount of memory, and computational power. Therefore, the same device can work both as the encryption and the decryption device. Only the outer component of the key determines in which mode, i.e., encryption or decryption, the device is currently working. Namely, the outer component of the key used for encryption a message can be transmitted along with the encrypted message so that the receiving device uses this public component as the public component of the decryption key. The present invention allows the internal parameters be chosen essentially at random from a large set of vectors. If the cryptosystem has m internal parameters each of which is a vector in the n-dimensional vector space V over the field of real numbers and the total size of the internal parameters is / binary bits, the security level is at least

2/ #(/ −1)!/[(n#m−1)!(/ −n#m)!

(Actually the security level is much higher because the size /can be arbitrarily big and not public.) For example, if there are 4 private internal parameters that occupy 128 bits and belong to the 3-dimensional real vector space, the security level of the cryptosystem is at least 2¹²⁸#2⁵⁰=2¹⁷⁸.

The creation of an encryption transformation (from the space of plaintexts to the space of ciphertexts) requires a choice of both an outer component and an inner component. Because of this the decryption transformation (from the space of ciphertexts to the space of plaintexts) cannot be reconstructed based solely on the outer component. Moreover, the continuous nature of the inner component leaves no chance to reconstruct it even in the case when both the outer component of the key and the ciphertext are publicly available. Even if, in addition to the outer component and the ciphertext, the plaintext is also publicly available, it is still impossible to reconstruct the inner component.

The outer components of keys of the cryptosystem of the present invention serve as the generators of both the encryption and decryption keys. In particular, the cryptosystem proposed by the present invention does not require the recipient of messages to communicate the outer component of the encryption key to the sender. In one embodiment, this outer component may be generated solely by the sender and sent to the recipient along with the encrypted message. In one embodiment, the outer component of the key can be attached as an initial segment of the transmitted message. In another embodiment, this outer component may be embedded in the encrypted message at equal distances between the digits of the message.

An important feature of the cryptosystem hereof is a dynamic and highly secure update of encryption and decryption keys. The security of the keys is guaranteed by the fact that their update proceeds without exchange of the new keys between communicating parties. Instead of such an exchange, the outer component of the encryption key, as embedded into the transmitted message, determines a new decryption key, which, in its turn, triggers the generation of a new decryption transformation. This update does not require any change in the inner component. Actually, any transmitted message may trigger a new decryption key generation. Therefore, the cryptosystem of the present invention overcomes a serious disadvantage of major private key cryptosystems: in such private key cryptosystems as DES or AES the encryption key does not change over a certain period of time, which fact encourages attacks against the cryptosystem. Unlike this, each time as the outer component is changed the cryptosystem hereof generates a new encryption transformation.

In one embodiment the outer component of the key is a sequence of positive integers. This sequence may be generated at random by using any distribution of the first m natural numbers. The security of the symmetric cryptosystem of the present invention comes from the built-in geometric continuity of plaintexts and ciphertexts as points of vector spaces as well as from the continuity of the inner components of encryption/decryption keys. In other words, security of the proposed cryptosystem is guaranteed by the obvious mathematical fact that there are potentially uncountably many geometric transformations of a given vector space.

An embodiment of the invention is in the form of a method for encryption and decryption a digital message M, comprising the following steps: producing a module V over a ring R; producing an outer component P of the encryption key that includes sequence (p₁, p₂, . . . , pₖ) where each member pⱼ of the sequence belongs to the set {1, 2, . . . , m} (the length k of the sequence is arbitrary and thus repetitions are allowed in the sequence); producing an inner component Q of the encryption key that includes elements v₁, v₂, . . . , vm of V and automorphisms g₁, g₂, . . . , gₘ of V; producing the encryption key K=(P; Q), where P is the outer component and Q is the inner component; producing an encryption automorphism Tₑ of V based on the encryption key K, where Tₑ includes a composition of certain automorphisms T₁, T₂, . . . , Tₘ of the module V which composition is performed in the order prescribed by P; producing an encrypted message element E as a function of a message element M in V and of the encryption automorphism Tₑ; transmitting the encrypted message element E along with the outer component P from one user to another; producing the outer component P′ of the decryption key that includes sequence (pₖ, pₖ₋₁, . . . , p₁), i.e., the sequence reversed of that involved in producing the outer component P of the encryption key; producing the decryption key K′=(P′; Q′), where P′ is the outer component of the decryption key and Q′ is the inner component of the decryption key which is equal to the inner component Q of the encryption key; producing a decryption automorphism T_{d} of V based on the decryption key K′, where T_{d} includes a composition of the automorphisms T₁, T₂, . . . , Tm, which composition is performed in the order prescribed by P′, e.g., T_{d} is the inverse automorphism of Tₑ; determining the message element M as a function of the encrypted message element E and of the decryption automorphism T_{d}, where the function is the same as that one used in generation of E (that is, the decryption method is symmetric to encryption: the decryption proceeds as the encryption, but with replacement of the outer component P with the outer component P′).

Further features and advantages of the invention will become more readily apparent from the following detailed description when taken in conjunction with the accompanying drawings.

### BRIEF DESCRIPTION OF DRAWINGS

FIG. 1 is a block diagram of a system that can be used in practicing embodiments of the invention.

FIG. 2 is a flow diagram of a symmetric encryption system which, when taken with the subsidiary flow diagrams referred to therein, can be used in implementing embodiments of the invention.

FIG. 3 is a flow diagram of a routine, in accordance with an embodiment of the invention, for generating outer component of the encryption key.

FIG. 4 is a flow diagram of a routine, in accordance with an embodiment of the invention, for generating the inner component of the encryption key using the outer component.

FIG. 5 is a flow diagram in accordance with an embodiment of the invention, for encryption a message using the inner component of the encryption key.

FIG. 6 is a flow diagram of a routine, in accordance with an embodiment of the invention, for generating the inner component of the decryption key using the outer component.

FIG. 7 is a flow diagram in accordance with an embodiment of the invention, for decryption a message using the inner component of the encryption key.

FIG. 8 is a flow diagram of a routine, in accordance with another embodiment of the invention, for generating the inner component of the encryption key using the outer component.

FIG. 9 is a flow diagram in accordance with another embodiment of the invention, for generating the inner component of the decryption key using the outer component.

### DETAILED DESCRIPTION

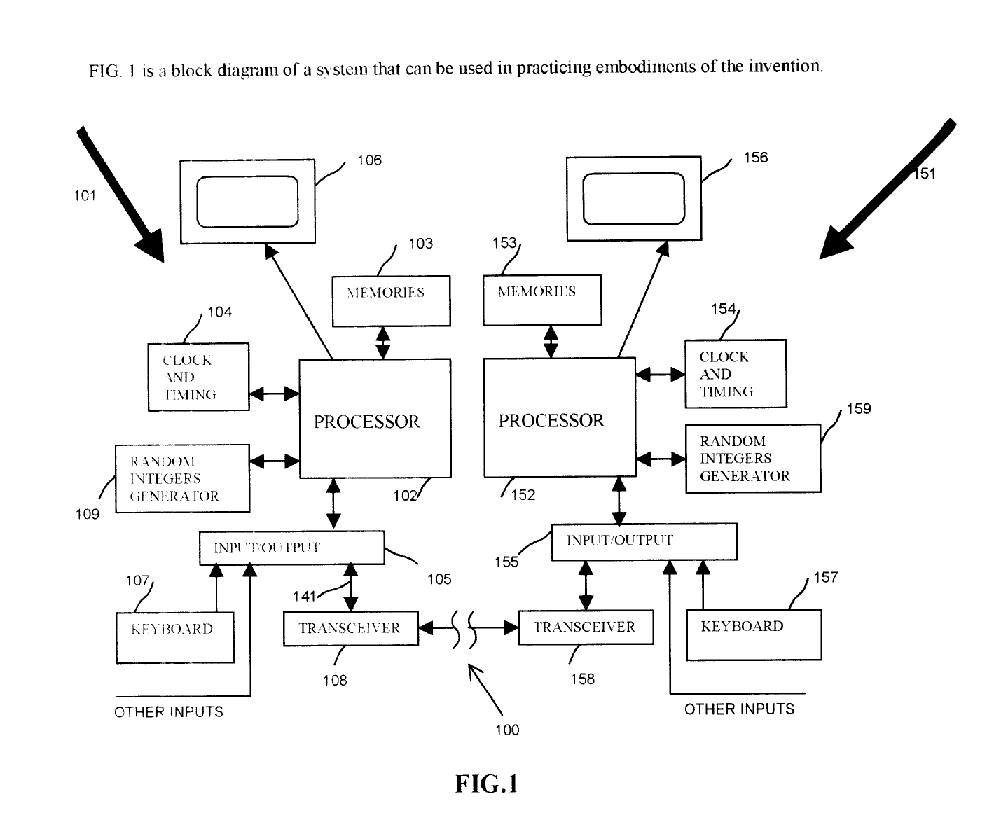

FIG. 1 is a block diagram of a system that can be used in practicing embodiments of the invention. Two processor-based subsystems 101 and 151 are shown as being in communication over an insecure channel 100, which may be, for example, any wired or wireless communication channel such as a telephone or internet communication channel. The subsystem 101 includes processor 102 and the subsystem 151 includes processor 152. When programmed in the manner to be described, the processors 102 and 152 and their associated circuits can be used to implement an embodiment of the invention and to practice an embodiment of the method of the invention. The processors 102 and 152 may each be any suitable processor, for example an electronic digital processor or microprocessor. It will be understood that any general purpose or special purpose processor, or other machine or circuitry that can perform the functions described herein, electronically, optically, or by other means, can be utilized. The processors may be, for example, Intel Pentium processors. The subsystem 101 will typically include memories 103, clock and timing circuitry 104, input/output functions 105 and monitor 106, which may all be of conventional types. Inputs can include a keyboard input as represented at 107. Communication is via transceiver 108, which may comprise a modem or any suitable device for communicating signals. The subsystem 151 in this illustrative embodiment can have a similar configuration to that of subsystem 101. The processor 152 has associated input/output circuitry 155, memories 153, clock and timing circuitry 154, and a monitor 156. Inputs include a keyboard 157. Communication of subsystem 151 with the outside world is via transceiver 158 which, again, may comprise a modem or any suitable device for communicating signals.

The encryption and decryption techniques of an embodiment of the symmetric cryptosystem hereof use a cryptosystem based on an action of the infinite group on a vector space. The security of the symmetric cryptosystem of the present invention hereof comes from the built-in geometric continuity of plaintexts and ciphertexts as points of vector spaces as well as from the continuity of the inner component of encryption/decryption keys performing transformations between plaintexts and ciphertexts. In other words, security of the proposed cryptosystem is guaranteed by the obvious mathematical fact that there are potentially uncountably many geometric transformations of a given vector space.

The cryptosystem hereof is essentially a private key symmetric cryptosystem because both decryption and encryption keys are of the similar structure and are not publicly available. Another similarity is that in the cryptosystem hereof formation of both encryption and decryption keys depends on fixed secret internal parameters. However, unlike in major private key symmetric cryptosystems like DES or AES there are in the cryptosystem hereof many different encryption/decryption keys corresponding to a chosen set of secret parameters. Namely, generation of a particular encryption/decryption key in the cryptosystem of the present invention depends, besides the fixed secret parameters, on a choice of certain publicly available data, which data is referred to as outer component. Another difference between the cryptosystem of the present invention and major private key cryptosystems is that the cryptosystem hereof requires neither sharing nor storing of encryption and decryption keys. In the cryptosystem hereof each message can be encrypted by its own encryption key independently of other messages. Each decryption key can be created upon receiving an encrypted message and does not have to be stored after the message has been decrypted. Thus the dynamic generation of encryption and decryption keys in the present invention eliminates the disadvantage of the major private key cryptosystems (like DES or AES) caused by the necessity of periodic change of the keys. Moreover, the present invention turns this disadvantage into a most efficient and attractive feature of the proposed cryptosystem. After a set of secret internal parameters has been chosen, the encryption key depends entirely on the publicly available data, i.e., the outer component. However, this encryption key is not public itself and the publicly available data do not necessarily come from the potential recipient of the message. Moreover, the decryption key of the present invention does not have to be an exclusive property of the potential recipient of the message. Knowledge of the outer component does not allow for constructing an encryption key unless the secret internal parameters of the cryptosystem are available. Thus, construction or reconstruction of any key in the cryptosystem hereof requires both a set of secret internal parameters and an outer component. The same outer component is used for constructing both encryption and decryption keys.

So far there is no literature describing cryptosystem embodying a geometric principle underlying the system hereof. Apparently an approach that is the closest to the present invention is developed in U.S. Pat. No. 5,740,250 entitled TAME AUTOMORPHISMPUBLIC KEY SYSTEM by Moh. The idea of using polynomial automorphisms in cryptography was developed in the patent. However, this is perhaps the only similarity because the Moh's patent addresses only the public key cryptosystem.

An embodiment of the cryptosystem hereof deals with the n-dimensional vector space V over the field of real numbers and a bilinear form L on V. A vector x in V can be written as an n-tuple of real numbers: x=[x₁, x₂, . . . , x n]. A bilinear form can be written as

L(x, y)=#/ _{i,j}#xᵢ#yⱼ,

where the summation is over all pairs (i,j) such that 1 #i,j#n, and all / _{i,j} are real numbers. The embodiment of the cryptosystem hereof depends on discrete parameters n and m, which are positive integers, and the set of continuous parameters: any vectors v₁, v₂, . . . , vₘ of V. In an embodiment the coordinates of the vectors of the cryptosystem hereof are presented by decimal real numbers having totally / decimal digits (therefore, the average number of digits in each coordinate is / /(n#m)). Therefore, the security level of the cryptosystem hereof is measured as the number of all such sets of parameters, i.e.,

10/ #(/ −1)!/[(n#m−1)!(/ −n#m)!].

For example, if n=3, m=4, / =72, the security level is measured as

10⁷²#(72−1)!/[(3#4−1)!(72−3#4)!]#2.5#10⁸⁴

(Actually the security level is much higher because the total number/of the digits can be arbitrarily big and is not public.) The following is an example of an embodiment in accordance with the invention of a symmetric key cryptosystem. The small numbers n=3, m=4, / #24 are used for ease of illustration, however, even with these small numbers the cryptosystem hereof is still cryptographically secure. Its security level is measured as at least 1.3#10³⁰#2¹⁰⁰. In creating a symmetric cryptosystem in accordance with an embodiment hereof (and with the previously indicated small numbers for ease of illustration), a first step is to choose integer parameters m, n. Take, for example n=3, m=4. Next, the bilinear form L is chosen to be the standard Euclidean dot product on V=R³, that is,

L(x, y)=x₁#y₁+x₂#y₂+x₃#y₃

for all x and y in R³. Some sequence of vectors v₁, v₂, V₃, V₄ is chosen as follows: v₁=[1,21,31], v₂=[2,30,40], v₃=[3,40,50], v₄=[4,50,6]. A plaintext message, for example, is the vector x=[4,5,6] of R³. Then:

L(x, v₁)=295, L(x, v₂)=398, L(x, v₃)=512, L(x, v₄)=302.

Furthermore,

L(v₁, v₁)=1403, L(v₂, v₂)=2504, L(v₃, v₃)=4109, L(v₄, v₄)=2552.

Therefore,

S₁(x)=[4,5,6]−2#(295/1403)#[1,21,31]=[3.579472559, −3.831076265, −7.036350677]

S₂(x)=[4,5,6]−2#(398/2504)#[2,30,40]=[3.364217252, −4.536741214, −6.715654952]

S₃(x)=[4,5,6]−2#(512/4109)#[3,40,50]=[3.25237284, −4.968362132, −6.460452665]

S₄(x)=[4,5,6]−2#(302/2552)#[4,50,6]=[3.053291536, −6.8338558, 4.579937304]

The above fractional numbers are computed with the precision of nine decimal places after the dot. In this example the numbers will be rounded up to two decimal places after the dot, that is,

S₁(x)=[3.58, −3.83, −7.04],

S₂(x)=[3.36, −4.54, −6.72],

S₃(x)=[3.25, −4.97, −6.46],

S₄(x)=[3.05, −6.83, 4.58].

To implement the cryptosystem of this example, the user of the processor-based system 101, call her Alice, decides to send a message to the user of the processor-based system 151, call him Bob. [It is assumed in this example that the processor-based systems 101 and 151 share the secret (i.e., available only to Alice and Bob) parameters v₁, v₂, v₃, v₄ and the (non-secret) standard dot-product L on V, defined as above]. Suppose that Alice [or the processor-based system 101] chooses k=8 and a sequence P of k integers: P=(1, 2, 3, 4, 1, 2, 3, 4) as the outer component of the encryption key [the restrictions on P in this example are that pⱼ# pⱼ₊₁ for j=1, 2, . . . , k−1, and all pⱼ are between 1 and 4; therefore, P can be chosen essentially at random within these limits]. Thus the encryption key K=(P, Q) is created, where Q is the inner component comprised of the parameters v₁, v₂, v₃, v₄. Based on this encryption key K, the processor-based system 101 creates the encryption automorphism Tₑ. This Tₑ is an automorphism of the space V defined by the formula

Tₑ=S₁°S₂°S₃°S₄°S₁°S₂°S₃°S₄,

where the reflections S₁, S₂, S₃, S₄ are as above. For example, suppose that Alice wants to send to Bob the message M=x=[4,5,6]. The processor-based system 101 encrypts this message using the constructed above encryption automorphism Tₑ. The processor-based systems 101 applies the encryption automorphism Tₑ to M and thus creates the encrypted message E given by

E=Tₑ(M)=[3.435583316, −4.617835082, −6.623621852].

The above fractional numbers are computed with the precision of nine decimal places after the dot. In this example the numbers comprising E are rounded up to two decimal places after the dot, that is, E is replaced by Eround, where

E_{round}=[3.44, −4.62, −6.62].

Then transceiver 108 sends the pair

(P; E_{round})=(1, 2, 3, 4, 1, 2, 3, 4; [3.44, −4.62, −6.62])

to the processor-based system 151. In the next part of the example, decryption of the received message is described. In order to decrypt the received message (P; E_{round}), the processor-based system 151 creates the decryption key K′=(P′;Q), where P′=(4, 3, 2, 1, 4, 3, 2, 1), that is, P′ is the reversed P, and Q is the inner component as above. Based on this decryption key K′ the processor-based system 151 creates the decryption automorphism T_{d} of the vector space V given by

T_{d}=S₄°S₃°S₂°S₁ °S₄°S₃°S₂°S₁

The processor-based system 151 decrypts the received message E_{round} by applying the automorphism T_{d}:

Mₐₚₚᵣₒₓ=T_{d}(E_{round})=[4.004794621, 5.000831229, 5.99630786].

The above fractional numbers are computed with the precision of nine decimal places after the dot. In this example processor-based system 151 rounds up these numbers to the closest integers, that is, it replaces Mₐₚₚᵣₒₓ by M_{round}, where M_{round}=[4,5,6]. This is the original message M. The fact that the coordinates of the decrypted message Mₐₚₚᵣₒₓ are sufficiently close to integers [that is, the distances between the coordinates and the closest integers are less than 0.01] indicates that there has not been any error during transmission of the message (P; E_{round}). Therefore, the cryptosystem of the present invention can also be used for detecting errors of transmission.

In a further embodiment of the invention the reflections Sᵢ will be replaced by the twisted eflections Tᵢ in order to further enhance the security level of the proposed cryptosystem. A twisted reflections embodiment of the cryptosystem hereof works in the n-dimensional vector space V over the field of real numbers and a bilinear form L on V. A vector x in V can be written as an n-tuple of real numbers:

x=[x₁, x₂, . . . , xₙ].

A bilinear form can be written as

L(x, y)=#/ _{i,j}#xᵢ#yⱼ,

where the summation is over all pairs (i,j) such that 1 #i,j#n, and all / _{i,j} are real numbers. The embodiment of the cryptosystem hereof depends on discrete parameters n and m, which are positive integers, and two sets of continuous parameters: any vectors v₁, v₂, . . . , vₘ of V and polynomial or (everywhere defined) rational automorphisms g₁, g₂, . . . , gm of V. In an embodiment the coordinates of the vectors of the cryptosystem hereof are presented by decimal real numbers having totally / decimal digits (therefore, the average number of digits in each coordinate is / /(n#m). Therefore, the security level of the cryptosystem hereof provided by the first set of parameters alone is measured as the number of all such sets of vectors, i.e.,

10/ #(/ −1)!/[(n#m−1)!(/ −n#m)!].

For example, if n=3, m=4, / =72, the security level is measured as

10⁷²#(72−1)!/[(3#4−1)!(72−3#4)!]#2.5#10⁸⁴.

(Actually the security level is much higher because the total number / of the digits is arbitrary big and not public.) In one embodiment when the polynomial or rational automorphisms g₁, g₂, . . . , gm are not public, they additionally enhance the security level of the cryptosystem. In another embodiment when the polynomial or rational automorphisms g₁, g₂, . . . , gₘ are public, their contribution to security consists of an additional defense against attacks on transmitted messages. More precisely, it is much harder to reconstruct the decryption automorphism T_{d} that is a non-linear (e.g., polynomial or rational) transformation of V than the decryption automorphism that is a linear transformation of V, i.e., an automorphism that is a matrix.

The following is an example of an embodiment in accordance with the invention of a symmetric cryptosystem. The small numbers n=3, m=4, / #24 are used for ease of illustration, however, even with these small numbers the cryptosystem hereof is still cryptographically secure. The automorphisms g₁, g₂, g₃, g₄ are considered public. Thus, in this example, the security level is measured as 1.3#10³⁰#2¹⁰⁰. In creating a symmetric cryptosystem in accordance with an embodiment hereof (and with the previously indicated small numbers for ease of illustration), a first step is to choose integer parameters m, n. Take, for example n=3, m=4. Next, the bilinear form L is chosen to be the standard Euclidean dot product on V=R³, that is,

L(x, y)=x₁#y₁+x₂#y₂+x₃#y₃

for all x and y in R³. Some sequence of vectors v₁, v₂, v₃, v₄ is chosen as follows: v₁=[1,21,31], v₂=[2,30,40], V₃=[3,40,50], V₄=[4,50,6]. And some second set of continuous parameters, i.e., the set of four automorphisms g₁, g₂, g₃, g₄, is chosen as follows:

g₁([x₁, x₂,x₃])=[x₁, x₂, x₃],

g₂([x₁, x₂, x₃])=[x₁, x₂, x₃],

g₃([x₁, x₂, x₃])=[x₁, x₂, x₃],

g₄([x₁, x₂, x₃])=[x₁, x₂+f(x₁), x₃], where

f(x₁)=(2x₁³+7x₁²+3x₁+10)/(3x₁²+5).

Then the twisted reflections T₁, T₂, T₃, T₄ are defined as above by:

T₁=g₁°S₁°g₁⁻¹, T₂=g₂°S₂°g₂⁻¹, T₃=g₃°S₃°g₃⁻¹, T₄=g₄°S₄°g₄⁻¹.

In this example T₁=S₁, T₂=S₂, T₃=S₃, but T₄#S₄. A plaintext message, for example, is the vector x=[4, 5, 6] of the vector space R³. Then:

L(x, v₁)=295, L(x, V₂)=398, L(x, v₃)=512, L(x, v₄)=302.

Furthermore,

L(v₁, v₁)=1403, L(v₂, V₂)=2504, L(v₃, v₃)=4109, L(v₄, v₄)=2552.

Therefore,

T₁(x)=S₁(x)=[4,5,6]−2#(295/1403)#[1,21,31]=[3.579472559, −3.831076265, −7.03635067

T₂(x)=S₂(x)=[4,5,6]−2#(398/2504)#[2,30,40]=[3.364217252, −4.536741214, −6.715654952]

T₃(x)=S₃(x)=[4,5,6]−2#(512/4109)#[3,40,50]=[3.25237284, −4.968362132, −6.460452665]

S₄(x)=[4,5,6]−2#(302/2552)#[4,50,6]=[3.053291536, −6.8338558, 4.579937304]

g₄(x)=[4, 9.943396227, 6]

g₄⁻¹(x)=[4, 0.056603774, 6]

S₄(g₄⁻¹(x))=[3.828118531, −2.091914592, 5.742177796]

T₄(x)=g₄(S₄(g₄⁻¹(x)))=[3.828118531, 2.733397735, 5.742177796]

The above fractional numbers are computed with the precision of nine decimal places after the dot. In this example the numbers will be rounded up to two decimal places after the dot, that is,

T₁(x)=S₁(x)=[3.58, −3.83, −7.04],

T₂(x)=S₂(x)=[3.36, −4.54, −6.72],

T₃(x)=S₃(x)=[3.25, −4.97, −6.46],

S₄(x)=[3.05, −6.83, 4.58],

g₄(x)=[4, 9.94, 6],

g₄⁻¹(x)=[4, 0.06, 6],

S₄(g₄⁻¹(x))=[3.83, −2.09, 5.74],

T₄(x)=g₄(S₄(g₄⁻¹(x)))=[3.83, 2.73, 5.74].

To implement the key creation of this example, the user of the processor-based system 101, call her Alice, decides to send a message to the user of the processor-based system 151, call him Bob. [It is assumed in this example that the processor-based systems 101 and 151 share the secret (i.e., available only to Alice and Bob) first set of parameters v₁, v₂, v₃, v₄, the (non-secret) standard dot product L on V, defined as above, and the (non-secret) second set of parameters g₁, g₂, g₃, g₄.] Suppose that Alice [or the processor-based system 101] chooses k=8 and a sequence P of k integers: P=(1, 2, 3, 4, 1, 2, 3, 4) as the outer component of the encryption key [the restrictions on P in this example are that pⱼ#pⱼ₊₁ for j=1, 2, . . . , k−1, and all pⱼ are between 1 and 4; therefore, P can be chosen essentially at random within these limits]. Thus the encryption key K=(P, Q) is created, where Q is the inner component comprised of the parameters v₁, v₂, v₃, v₄ and g₁, ₂, g₃, g₄. Based on this encryption key K, the processor-based system 101 creates the encryption automorphism Tₑ. This Tₑ is an automorphism of the space V defined by the formula

Tₑ=T₁°T₂°T₃°T₄°T₁°T₂°T₃°T₄,

where T₁, T₂, T₃, T₄ are twisted reflections, as defined above. For example, suppose that Alice wants to send to Bob the message M=x=[4,5,6]. The processor-based system 101 encrypts this message using the constructed above encryption automorphism Tₑ. The processor-based systems 101 applies Tₑ to M and thus creates the encrypted message E given by

E=Tₑ(M)=[4.42453245, 6.72134463, −13.76860997].

The above fractional numbers are computed with the precision of eight decimal places after the dot. In this example the numbers comprising E are rounded up to two decimal places after the dot, that is, E is replaced by Eround, where E_{round}=[4.42, 6.72, −13.77]. Then transceiver 108 sends the pair

(P; E_{round})=(1, 2, 3, 4, 1, 2, 3, 4; [4.42, 6.72, −13.77])

In the next part of the example, decryption of the received message is described. In order to decrypt the received message (P; E_{round}), the processor-based system 151 creates the decryption key K′=(P′;Q), where P′=(4, 3, 2, 1, 4, 3, 2, 1), that is, P′ is the reversed P, and Q is the inner component as above. Based on this decryption key K′ the processor-based system 151 creates the decryption automorphism T_{d} of the vector space V given by

T_{d}=T₄°T₃°T₂°T₁°T₄°T₃°T₂°T₁.

The processor-based system 151 decrypts the received message E_{round} by applying the decryption automorphism T_{d}:

Mₐₚₚᵣₒₓ=T_{d}(E_{round})=[3.99511743, 4.99555740, 6.00656969].

The above fractional numbers are computed with the precision of eight decimal places after the dot. In this example processor-based system 151 rounds up these numbers to the closest integers, that is, it replaces Mₐₚₚᵣₒₓ by the vector M_{round}, where M_{round}=[4,5,6]. This is the original message M. The fact that the coordinates of the decrypted message Mₐₚₚᵣₒₓ are sufficiently close to integers [that is, the distances between the coordinates and the closest integers are less than 0.01] indicates that there have not been any errors during transmission of the message (P; E_{round}). Therefore, the cryptosystem of the present invention can also be used for detecting errors of transmission.

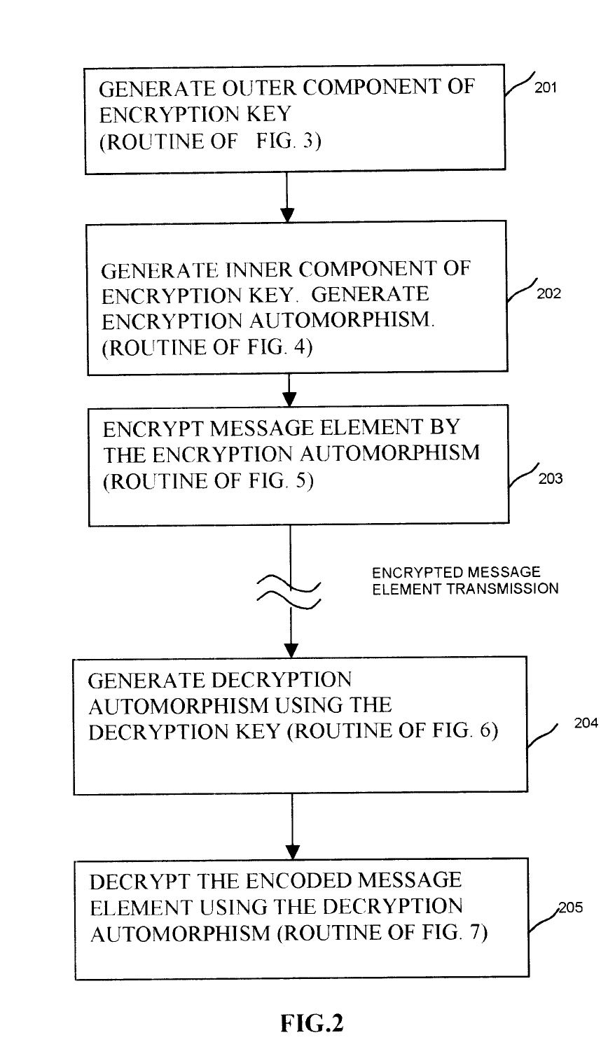

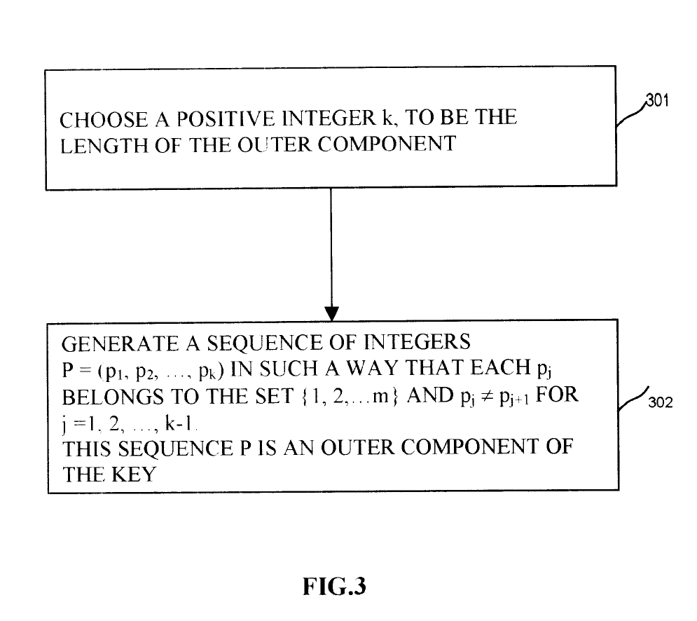

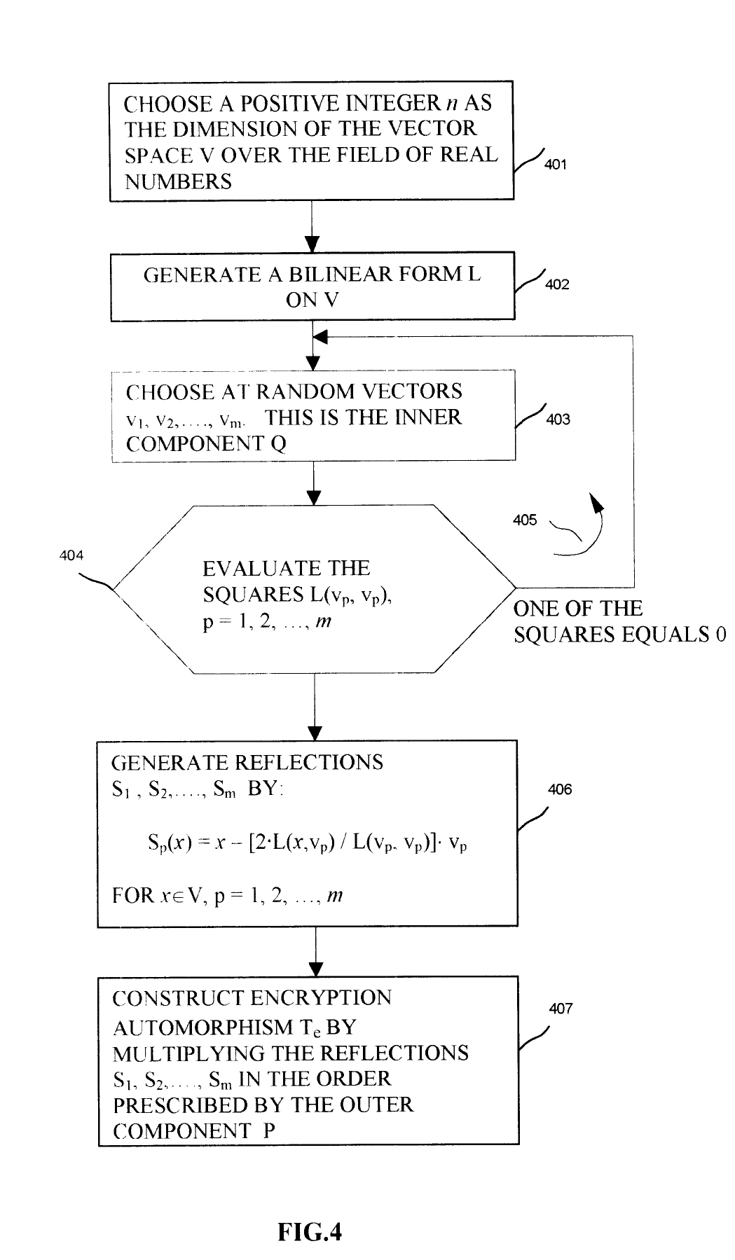

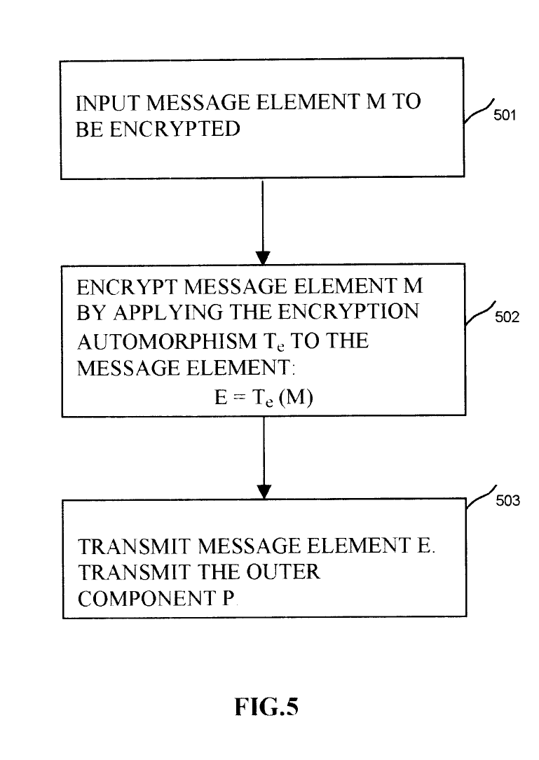

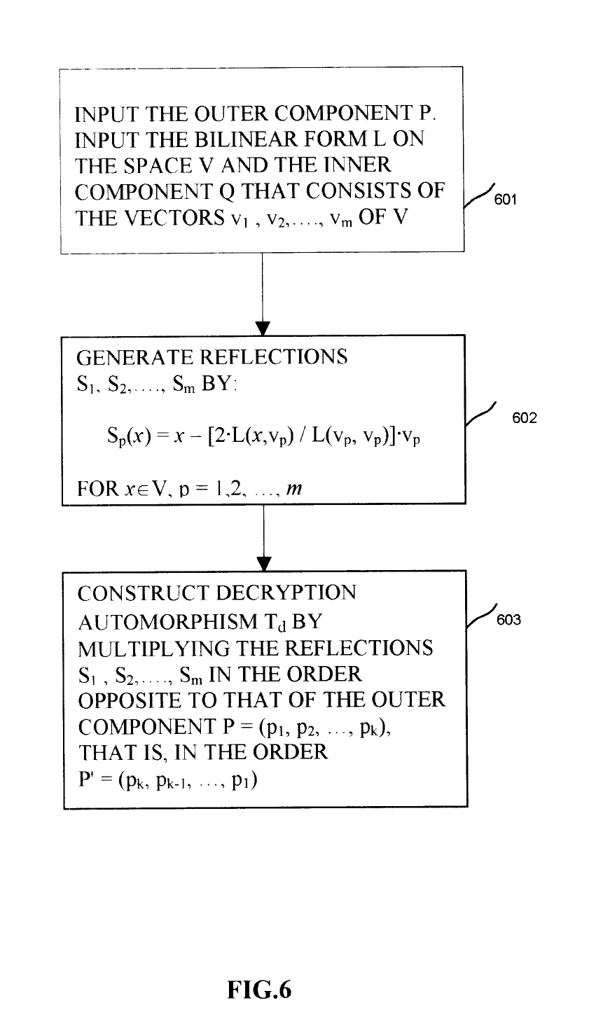

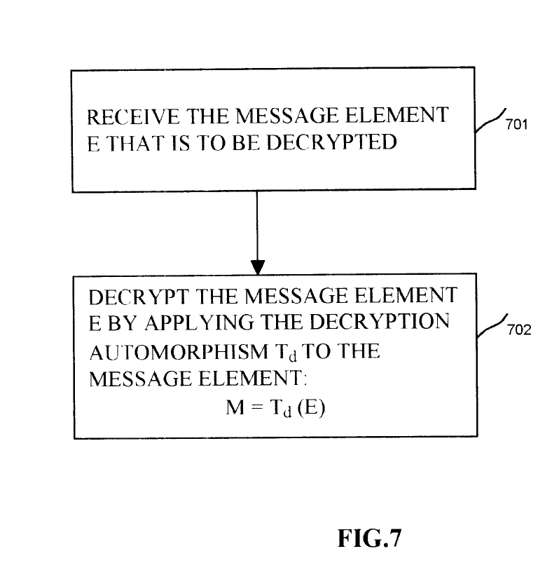

FIG. 2 illustrates a basic procedure that can be utilized with a symmetric encryption system, and refers to routines illustrated by other referenced flow diagrams which describe features in accordance with an embodiment of the invention. The block 201 represents the generating of the outer component of the encryption key. The routine of an embodiment hereof is described in conjunction with the flow diagram of FIG. 3. In the present example, it can be assumed that this operation is performed at the processor-based system 101. The outer component information can be published. For example, “publishing” of the outer component information can be performed by the sender of the encrypted message. In particular, the outer component information can be transmitted by the sender of the encrypted message along with the message. Typically, although not necessarily, each transmitted message has its own outer component of the key that is generated by the sender. In the present example, it is assumed that the user of the processor-based system 101 wants to send a confidential message to the user of processor-based system 151, and that the user of processor-based system 101 can generate this outer component of the key within processor-based system 101. The block 202 represents the routine that can be used by the message sender (that is, in this example, the user of processor-based system 101) to generate inner component of the encryption key and the corresponding encryption automorphism. This routine, for an embodiment of the invention, is described in conjunction with the flow diagram of FIG. 4. The block 203 represents the routine that can be used by the message sender (that is, in this example, the user of processor-based system 101) to encrypt the plaintext message using the encryption automorphism. This routine, in accordance with an embodiment of the invention, is described in conjunction with the flow diagram of FIG. 5. The encrypted message is then transmitted over the channel 100 (FIG. 1). The block 204 represents the routine that can be used by the message recipient (that is, in this example, the user of processor-based system 151) to generate the decryption automorphism using the decryption key that, in its turn, is produced based on the outer component generated in the block 201 and the inner component generated in the block 202. The decryption automorphism generating routine, for an embodiment of the invention, is described in conjunction with the flow diagram of FIG. 6. The block 205 of FIG. 2 represents the routine for the decryption of the encrypted message to recover the plaintext message. In the present example, this function is performed by the user of the processor-based system 151, who employs the decryption automorphism generated in the block 204. The decryption routine, for an embodiment of the invention, is described in conjunction with the flow diagram of FIG. 7.

FIG. 3 represents generation of the outer component of the encryption key. First, the length k of the outer component is chosen in the block 301. Then the outer component P is generated in the block 302: P is a sequence (p₁, p2, . . . , pₖ) of length k each member pⱼ of which is an integer between 1 and m [where m is the size of the set of internal parameters]. P is generated at random in such a way that pⱼ#pⱼ₊₁ for j=1, 2, . . . , k−1.

Referring now to FIG. 4, there is shown a flow diagram of the routine, as represented generally by the block 202 of FIG. 2, for generating the inner component of encryption key and the corresponding encryption automorphism Tₑ. The routine can be utilized, in the present example, for programming the processor 102 of the processor-based system 101. The block 401 represents the choosing of a positive integer n. As first described above, n determines the dimension of the vector space V over the field of real numbers. The block 402 represents the generation of L, which is the bilinear form on the n-dimensional vector space V. In the simplified example above, L was a standard Euclidean dot product on V. Next, the block 403 represents the choosing at random vectors v₁, v₂, . . . , vₘ. These vectors serve as internal parameters of the cryptosystem and, in this embodiment they comprise the inner component Q of the encryption key. The coordinates of the vectors may, for example, be chosen using a random number generator, which can be implemented, in known fashion, using available hardware or software. In the present embodiment, each of the processor-based systems is provided with a random number generator, designated by the blocks 109 and 159 respectively, in FIG. 1. The block 404 represents computation of the squares of the vectors v₁, v₂, . . . , vₘ with respect to the bilinear form L. If L(vₚ, vₚ)=0 for at least one index p, the block 403 is re-entered, and a new corresponding vector vₚ is chosen. The loop 405 is continued until all the squares become non-zero. [The probability of emerging a square equal 0 is extremely low. Moreover, if L is a standard Euclidean dot product, each non-zero vector of V has a positive (hence, non-zero) square with respect to the dot product and, therefore, the loop 405 does not take place.] The block 406 is then entered, this block is representing the generation of reflections S₁, S₂, . . . , Sₘ relative to the vectors v₁, v₂, . . . , vₘ respectively according to

Sₚ(x)=x−[2L(x,vₚ)/L(vₚ, vₚ)]#vₚ

for p=1, 2, . . . , m as first described above. The block 407 represents construction of the encryption automorphism Tₑ by multiplying reflections S₁, S₂, . . . , Sₘ in the order prescribed by the outer component P=(p₁, p₂, . . . , pₖ), in accordance with

Tₑ=Sₚ₁°Sₚ₂° . . . °Sₚₖ

as first described above [that is, Tₑ is obtained by multiplying the reflections S₁, S₂, . . . , Sₘ in the order prescribed by the outer component P=(p₁, p₂, . . . , pₖ).]

FIG. 5 is a flow diagram, represented generally by the block 203 of FIG. 2, of a routine for programming a processor, such as the processor 102 of the processor-based system 101 (FIG. 1) to implement encryption of a plaintext message M. The message to be encrypted is input (block 501). The encrypted message, E, can then be computed (block 502) as E=Tₑ(M), where Tₑ is the encryption automorphism constructed in the block 407 of FIG. 4. The encrypted message can be transmitted (block 503) over channel 100 to the recipient who, in the present example, is the user of the processor-based system 151.

FIG. 6 is a flow diagram of the routine, as represented generally by the block 204 of FIG. 2, for generating the decryption automorphism. The routine can be utilized, in the present example, for programming the processor 152 of the processor-based system 151. It can be assumed in the present example that, prior to receiving the message, the recipient of the message possesses the parameters of the cryptosystem: the vector space V, the bilinear form L, and a set of internal parameters: the vectors v₁, v₂, . . . , vₘ that, in the present embodiment, comprise the inner component Q. [In particular, the set of private parameters v₁, v₂, . . . , vₘ can be communicated to the recipient over a secure channel of communication.] The block 601 represents inputting the parameters [that is, V, L, and v₁, v₂, . . . , vₘ] into the processor-based system 151. The block 602 is then entered, this block represents the generation of reflections S₁, S₂, . . . , Sₘ relative to the vectors v₁, v₂, . . . , vₘ respectively according to

Sₚ(x)=x−[2L(x,vₚ)/L(vₚ, vₚ)]#vₚ

for p=1, 2, . . . , m as first described above. The block 603 represents construction of the decryption automorphism T_{d} by multiplying reflections S₁, S₂, . . . , Sₘ in the order opposite to that of the outer component P=(p₁, p₂, . . . , pₖ), in accordance with

T_{d}=Sₚₖ° . . . °Sₚ₂°Sₚ₁

as first described above. [In other words, the construction of the decryption automorphism T_{d} proceeds in the same way as the construction of the encryption automorphism Tₑ but in the order prescribed by the sequence P′=(pₖ, pₖ₋₁, . . . , p₁) which is the reversed outer component P=(p₁, p₂, . . . , pₖ).]

FIG. 7 is a flow diagram, represented generally by the block 205 of FIG. 2, of a routine for programming a processor, such as the processor 152 of the processor-based system 151 (FIG. 1) to implement decryption of a received encrypted message E. The message E is received (block 701). The decrypted message M can then be computed (block 702) as M=T_{d}(E), where T_{d} is the decryption automorphism constructed in the block 603 of FIG. 6.

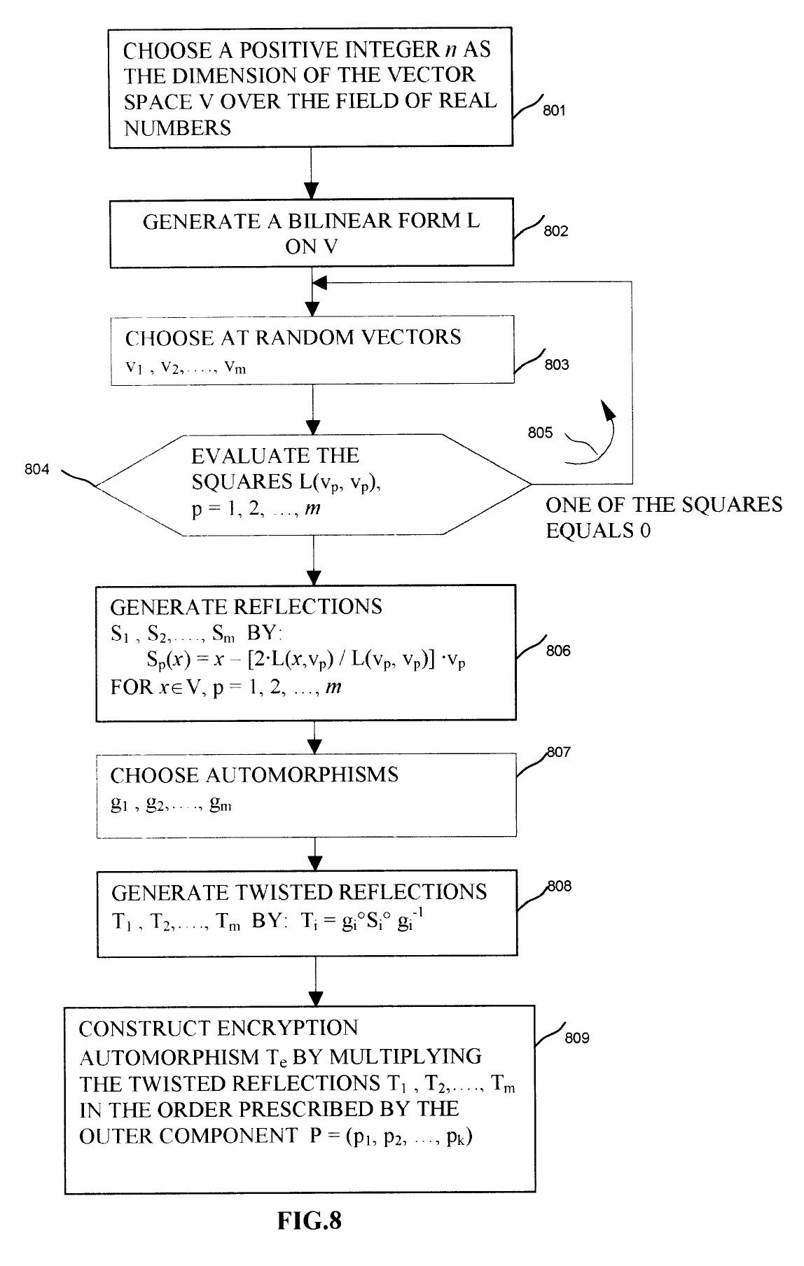

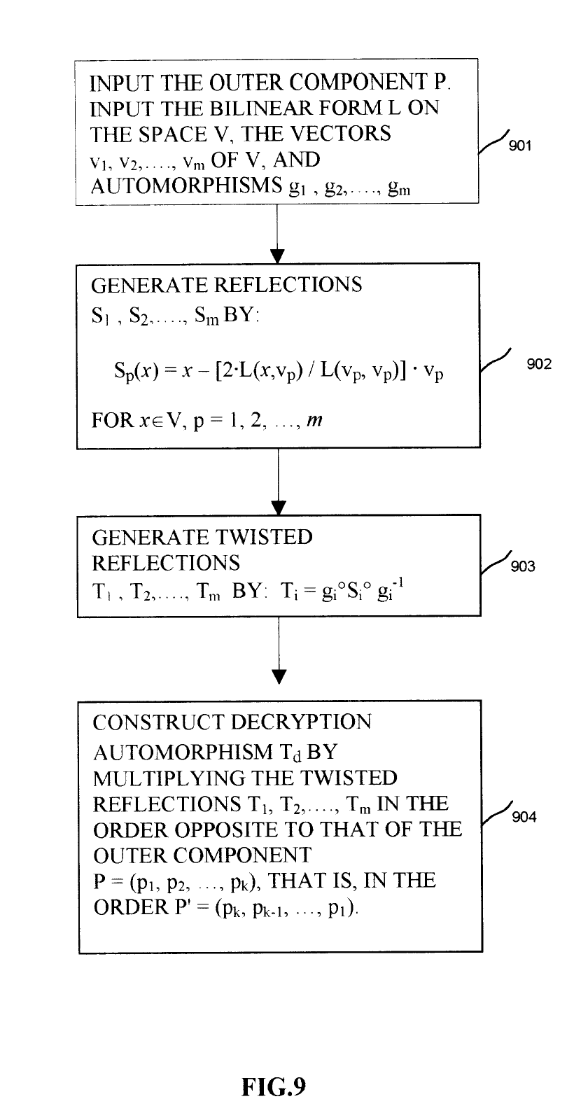

FIGS. 8 and 9 are flow diagrams relating to the above-described twisted reflections embodiment. FIG. 8 is a flow diagram of the routine, as represented generally by the block 202 of FIG. 2, for generating the inner component of encryption key and the corresponding encryption automorphism Tₑ. As above, the routine can be utilized, in the present example, for programming the processor 102 of the processor-based system 101. The block 801 represents the choosing of a positive integer n. As first described above, n determines the dimension of the vector space V over the field of real numbers. The block 802 represents the generation of L, which is the bilinear form on the n-dimensional vector space V. In the simplified example above, L was a standard Euclidean dot product on V. Next, the block 803 represents the choosing at random vectors v₁, v₂, . . . , vₘ. These vectors serve as the first set of the internal parameters of the cryptosystem. The coordinates of the vectors may, for example, be chosen using a random number generator, which can be implemented, in known fashion, using available hardware or software. In the present embodiment, each of the processor-based systems is provided with a random number generator, designated by the blocks 109 and 159 respectively, in FIG. 1. The block 804 represents computation of the squares of the vectors v₁, v₂, . . . , vₘ with respect to the bilinear form L. If L(vₚ, vₚ)=0 for at least one index p, the block 803 is re-entered, and a new corresponding vector vₚ is chosen. The loop 805 is continued until all the squares become non-zero. [The probability of emerging a square equal 0 is extremely low. Moreover, if L is a standard Euclidean dot product, each non-zero vector of V has a positive (hence, non-zero) square with respect to the dot product and, therefore, the loop 805 does not take place.] The block 806 is then entered, this block represents the generation of reflections S₁, S₂, . . . , Sₘ relative to the vectors v₁, v₂, . . . , vm respectively according to

Sₚ(x)=x−[2L(x,vₚ)/L(vₚ, vₚ)]#vₚ

for p=1, 2, . . . , m as first described above. The block 807 represents selection of a set of polynomial or rational automorphisms g₁, g₂, . . . , gₘ of the vector space V. These automorphisms serve as the second set of the internal parameters of the cryptosystem. These automorphisms (along with the first set of internal parameters v₁, v₂, . . . , vₘ) form the inner component Q of the encryption key. The automorphisms are chosen at random as compositions of linear automorphisms of V and the basic polynomial automorphisms of the form described above:

g(x₁, x₂, . . . xₙ)=(x₁, x₂+f₁(x₁), x₃+f₂(x₁, x₂), . . . xₙ+fₙ₋₁(x₁, x₂, . . . , xn₋₁)),

where fⱼ: R^{j}# R for j=1, 2, . . . , n−1 are rational maps. Each of the maps fⱼ is chosen recursively at random using, for example, a random number generator, which can be implemented, in known fashion, using available hardware or software. In the present embodiment, each of the processor-based systems is provided with a random number generator, designated by the blocks 109 and 159 respectively, in FIG. 1. The block 808 represents generation of the twisted reflections T₁, T₂, . . . , Tₘ in accordance with Tₚ=gₚ°Sₚ°gₚ⁻¹ for p=1, 2, . . . , m. The block 809 represents construction of the encryption automorphism Tₑ in accordance with

Tₑ=Tₚ₁°Tₚ₂° . . . °Tₚₖ

as first described above [that is, Tₑ is obtained by multiplying the twisted reflections T₁, T₂, . . . , Tₘ in the order prescribed by the outer component P=(p₁, p₂, . . . , pₖ).]

FIG. 9 is a flow diagram of the routine, as represented generally by the block 204 of FIG. 2, for generating the decryption automorphism T_{d} of the present twisted reflections embodiment. The routine can be utilized, in the present example, for programming the processor 152 of the processor-based system 151. It can be assumed in the present example that, prior to receiving the message, the recipient of the message possesses the parameters of the cryptosystem: the vector space V, the bilinear form L, and two sets of internal parameters: the vectors v₁, v₂, . . . , vₘ of V, and the polynomial or rational automorphisms g₁, g₂, . . . , gₘ of V. These two sets of parameters, in the present embodiment, comprise the inner component Q. In one embodiment of the present example both the vectors v₁, v₂, . . . , vₘ and the automorphisms g₁, g₂, . . . , gₘ can be considered private parameters. In another embodiment, only the vectors v₁, v₂, . . . , vₘ can be considered private, while the automorphisms g₁, g₂, . . . , gₘ can be considered public parameters. [In particular, the private parameters v₁, v₂, . . . , vₘ can be communicated to the recipient over a secure channel of communication.] In another embodiment, only the automorphisms g₁, g₂, . . . , gₘ can be considered private, while the vectors v₁, v₂, . . . , vₘ can be considered public parameters. The block 901 represents inputting the parameters [that is, V, L, and v₁, v₂, . . . , vₘ; g₁, g₂, . . . , gₘ] into the processor-based system 151. The block 902 is then entered, this block represents the generation of reflections S₁, S₂, . . . , Sₘ relative to vectors v₁, v₂, . . . , vₘ respectively according to

Sₚ(x)=x−[2L(x,vₚ)/L(vₚ, vₚ)]#vₚ

for p=1, 2, . . . , m as first described above. The block 903 represents generation of the twisted reflections T₁, T₂, . . . , Tₘ in accordance with Tₚ=gₚ°Sₚ°gₚ⁻¹ for p=1, 2, . . . , m. The block 904 represents construction of decryption automorphism T_{d} by multiplying the twisted reflections T₁, T₂, . . . , Tₘ in the order opposite to that of the outer component P=(p₁, p₂, . . . , pₖ), in accordance with

T_{d}=Tₚₖ° . . . Tₚ₂°Tₚ₁

which proceeds in the same way as the construction of the encryption automorphism Tₑ but in the order prescribed by the sequence P′=(pₖ, pₖ₋₁, . . . , p₁) which is the reversed outer component P=(p₁, p₂, . . . , pₖ).]

The invention has been described with reference to particular preferred embodiments, but variations within the spirit and scope of the invention will occur to those skilled in the art. For example, it will be understood that the internal parameters of the cryptosystem can be stored on any suitable media, for example a “smart card,” which can be provided with a microprocessor capable of constructing encryption/decryption keys and performing encryption/decryption processes, so that encrypted messages can be communicated to and/or from the smart card.

1. A method of communicating information between users of a communication system includes the following steps of:
generating a module V over a ring R;
generating an outer component P of encryption key that includes sequence (p₁, p₂, . . . , pₖ) where each member pⱼ of the sequence belongs to the set {1, 2, . . . , m} (the length k of the sequence is arbitrary and thus repetitions are allowed in the sequence);
generating an inner component Q of encryption key that includes elements v₁, v₂, . . . , vₘ of V and automorphisms g₁, g₂, . . . , gₘ of V;
generating the encryption key K=(P; Q), where P is the outer component and Q is the inner component;
generating an encryption automorphism Tₑ of V based on the encryption key K, where Tₑ includes a composition of certain automorphisms T₁, T₂, . . . , Tₘ of the module V, which composition is performed in the order prescribed by P;
generating an encrypted message element E as a function of a message element M in V and of the encryption automorphism Tₑ;
transmitting the encrypted message element E along with the outer component P from one user to another;
generating the outer component P′ of decryption key that includes sequence (pₖ, pₖ₋₁, . . . , p₁), i.e., the sequence that is reversed of that involved in producing the outer component P of the encryption key;
generating the decryption key K′=(P′; Q′), where P′ is the outer component of the decryption key and Q′ is the inner component of the decryption key which is equal to the inner component Q of the encryption key;
generating a decryption automorphism T_{d} of V based on the decryption key K′, where T_{d} includes a composition of the automorphisms T₁, T₂, . . . , Tₘ, which composition is performed in the order prescribed by P′, e.g., T_{d} is the inverse automorphism of Tₑ;
determining the message element M as a function of the encrypted message element E and of the decryption automorphism T_{d}, where the function is the same as that one used in generation of E (that is, the decryption method is symmetric to encryption: the decryption proceeds as the encryption, but with replacement of the outer component P with the outer component P′).

2. The method as defined by claim 1, wherein the ring R is any commutative or non-commutative ring.

3. The method as defined by claim 1, wherein said V is a projective module over the ring R.

4. The method as defined by claim 1, wherein said V is a free R-module of dimension n, and where n is an integer greater than 1.

5. The method as defined by claim 4, wherein the R-module V is the standard free module Rⁿ, that is, V is the set of all n-tuples x=[x₁, x₂, . . . , xₙ] of elements of R.

6. The method as defined by claim 2, wherein said ring R is the field of real numbers.

7. The method as defined by claim 2, wherein said ring R is the skew-field of quaternions.

8. The method as defined by claim 2, wherein said ring R is a finite field.

9. The method as defined by claim 2, wherein the ring R is the ring of matrices over the field of real numbers.

10. The method as defined by claim 1, wherein said step of generating said automorphisms T₁, T₂, . . . , Tₘ further comprises generating automorphisms T₁, T₂, . . . , Tₘ of finite orders.

11. The method as defined by claim 10 further comprises generation of each automorphism Tᵢ of the order 2.

12. The method as defined by claim 10, wherein said index i is used in the derivation of said outer component of the encryption or decryption keys and said element Tᵢ is a part of said encryption and decryption automorphisms.

13. The method as defined by claim 1, wherein said message element M is an element of said module V.

14. The method as defined by claim 13, wherein the encrypted message element E is obtained by applying said automorphism Tₑ (as defined in the claim 1) to the message element M.

15. The method as defined by claim 1, wherein said encrypted message element is produced by a user at one location, transmitted from said one location to another location, and decrypted by a user at said another location.

16. A method of communicating information between users of a communication system, the method comprising the steps of:
generating a module V over a ring R; generating an outer component P of encryption key: P=(p₁, p₂, . . . , pₖ) where each member pⱼ of the sequence belongs to the set {1, 2, . . . , m};
generating an inner component Q of encryption key that includes elements v₁, v_{2,} . . . _{,} vₘ of said module V and automorphisms g₁, g₂, . . . , gₘ of V;
generating the encryption key K=(P; Q), where P is the outer component and Q is the inner component;
generating an encryption automorphism Tₑ of the module V based on automorphisms T₁, T₂, . . . , Tₘ of the module V and on the outer component P=(p₁, p₂, . . . , pₖ) of encryption key: Tₑ=Tₚ₁°Tₚ₂° . . . Tₚₖ. That is, Tₑ is an automorphism of the module V obtained as a composition of automorphisms T₁, T₂, . . . , Tₘ, which composition is performed in the order prescribed by P;
generating an encrypted message element E as a function of a message element M in V and of the encryption automorphism Tₑ;
transmitting the encrypted message element E along with the outer component P from one user to another;
generating an outer component P′=(pₖ, pₖ₋₁, . . . p₁), i.e., the sequence that is reversed of that involved in producing the outer component P of the encryption key;
generating the decryption key K′=(P′; Q′), where P′ is the outer component of the decryption key and Q′ is the inner component of the decryption key which is equal to the inner component Q of the encryption key;
generating a decryption automorphism T_{d} of the module V based on automorphisms T₁, T₂, . . . , Tₘ of the module V and on the outer component P′=(pₖ, pₖ₋₁, . . . p₁) of the decryption key: Tₑ=Tₚₖ° . . . Tₚ₂°Tp1, where T₁, T₂, . . . , Tₘ are the same automorphisms of V which have been used in the construction of the encryption automorphism Tₑ; determining the message element M as a function of the encrypted message element E and of the decryption automorphism T_{d}, where the function is the same as that one used in generation of E (that is, the decryption method is symmetric to encryption: the decryption proceeds as the encryption, but with replacement of the outer component P with the outer component P′).

17. The method as defined by claim 16, wherein said encrypted message element M is produced as
E=Tₑ(M),
where Tₑ(M) is the element of V obtained by applying the automorphism Tₑ to said message element M.

18. The method as defined by claim 16, wherein said decrypted message element M is produced as
M=T_{d}(E),
where T_{d}(E) is the element of V obtained by applying the automorphism Td to said encrypted message element E.

19. The method as defined by claim 16, of further selecting non-zero elements v₁, v₂, . . . , vₘ of the module V.

20. The method as defined by claim 16, of construction of R-linear maps / p:V # R, for p=1, 2, . . . , m, such that / ₚ(vₚ)=2.

21. The method as defined by claim 16, wherein said step of generating said automorphisms T₁, T₂, . . . , Tₘ of V includes selecting automorphisms g₁, g₂, . . . , gₘ of V and reflections S₁, S₂, . . . Sₘ of V.

22. The method as defined by claim 21, wherein said elements T₁, T₂, . . . , Tₘ are defined by:
Tₚ=gₚ°Sₚ°hₚ,
where hₚ is the inverse automorphism of gₚ, that is,
gₚ°hₚ=hₚ°gₚ=the identity automorphism of V,
and Sₚ is the reflection of V relative to the element vₚ, as defined in claim 19, and an R-linear map / ₚ:V # R as defined in claim 20. That is, Sₚ is defined by:
Sₚ(x)=x−/ ₚ(x)#vₚ
for any x in V.

23. The method as defined by claim 21 where each gᵢ is a polynomial automorphism of the module V. By definition, a map g: U#V from a R-module U to R-module V is called polynomial map if for any elements u₁, u₂, . . . , uᵣ of U there is a finite family of elements v_{J} labeled by finite sequences J=(j₁, j₂, . . . ) of indices each of which belongs to the set {1, 2, . . . , r} such that for any elements a₁, a₂, . . . , aᵣ of R one has:
g(a₁#u₁+a₂#u₂+ . . . +aᵣ#uᵣ)=#(^{a}jᵢ#^{a}j₂###^{a}jᵣ)#v_{J},
where summation is over all J=(j₁, j₂, . . . ) as above. A map g: V # V is a polynomial automorphism if g is invertible and both g and inverse of g are polynomial maps.

24. The method as defined by claim 21 where each gᵢ is a rational automorphism of the module V. By definition, a partially defined map g: U # V from a R-module U to R-module V is called rational if there exists a polynomial map f: U # R and a polynomial map h: U # V such that h(u)=f(u)#g(u) for all u in the domain of g.

25. The method as defined by claims 5 and 23 of constructing polynomial automorphisms gᵢ of the free module V=Rⁿ, where each gᵢ belongs to that group of polynomial automorphisms of V which is generated by all R-linear invertible maps V # V and by all the polynomial automorphisms g: V# V of the form:
g(x₁, x₂, . . . , xₙ)=(x₁, x₂+f₁(x₁), x₃+f₂(x₁, x₂), . . . , xₙ+fₙ₋₁(x₁, x₂, . . . xₙ₋₁)),
where fᵢ: Rⁱ # R for i=1, 2, . . . , n−1 are polynomial maps.

26. The method as defined by claims 5 and 24 of constructing rational automorphisms gᵢ of the free module V=Rⁿ, where each gᵢ belongs to that group of rational automorphisms of V which is generated by all R-linear invertible maps V # V and by all the rational automorphisms g: V# V of the form:
g(x₁, x₂, . . . , xₙ)=(x₁, x₂+f₁(x₁), x₃+f₂(x₁, x₂), . . . , xₙ+fₙ₋₁(x₁, x2, . . . , xₙ₋₁)),
where fᵢ: Rⁱ# R for i=1, 2, . . . , n−1 are rational maps.

27. The method for construction of rational automorphisms fᵢ: Rⁱ # R, as of claim 26, where the domain of each fᵢ is the entire Rⁱ, where R is the field of real numbers as in claim 6.

28. The method of claim 27, where each fᵢ is of the form:
fᵢ(x₁, x₂, . . . , xᵢ)=Pᵢ(x₁, x₂, . . . , xᵢ)/Qᵢ(x₁, x₂, . . . , xᵢ),
where Pᵢ (x₁, x₂, . . . , xᵢ) and Qᵢ (x₁, x₂, . . . , xᵢ) are polynomials with real coefficients in the variables x₁, x₂, . . . , xᵢ such that Qᵢ(x₁, x₂, . . . , xₙ)>0 for any real numbers x₁, x₂, . . . , xₙ.

29. The method as defined by claim 22, of further construction of the R-linear map / ₚ: V # R by means of a map L: V×V # R, which is left R-linear, that is,
L(a#x+b#y, v)=a#L(x,v)+b#L(y,v)
for any elements x, y, and v of V, and any elements a and b of R, where ‘#’ stands for the action of the ring R on the module V.

30. The method of selecting elements v₁, v₂, . . . , vₘ of the claim 19 that provides that L(vₚ, vₚ) # 0 for each p=1, 2, . . . , m.

31. The method as defined by claim 29, of further selecting elements v₁, v₂, . . . , vₘ satisfying the property that for each p=1, 2, . . . , m there exists an element rₚ in R such that L(vₚ, vₚ)#rₚ=2.

32. The method of claims 20, 29, and 31 for construction of a R-linear map / ₚ: V # R by
/ ₚ(x)=L(x,vₚ)#rₚ
for all x in V, p=1, 2, . . . , m.

33. The method of claims 6, 20, 30, and 32 for construction of a R-linear map / ₚ: V # R by
/ ₚ(x)=2L(x,vₚ)/L(vₚ,vₚ)
for all x in V, p=1, 2, . . . , m.

34. The method of claims 6, 20, 22, 30, and 32 for construction of a reflection Sₚ: V # V by
Sₚ(x)=x−2L(x,vₚ)/L(vₚ,vₚ)#vₚ
for all x in V, p=1, 2, . . . , m.

35. The method as defined by claims 5 and 29, wherein the left R-linear map L is a bi-linear form on V=Rⁿ, i.e.,
L(x,y)=x₁#f₁(y₁)+x₂#f₂(y₂)+ . . . +xₙ#fₙ(yₙ)
where each fᵢ:R # R for i=1, 2, . . . , n is a polynomial.

36. The method as defined by claims 5 and 29, wherein the left R-linear map L on V=Rⁿ is further defined by:
L(x,y)=#xᵢ#/ _{i,j}#yⱼ
for any x, y # Rⁿ, where the summation is over all pairs (i,j) such that 1#i,j#n, and / _{i,j} in R for i=1, 2, . . . , n and j=1, 2, . . . , n.

37. The method as defined by claim 36, wherein the left R-linear map L is the standard bilinear form on V=Rⁿ further defined by:
L(x,y)=x₁#y₁+x₂#y₂+ . . . +xₙ#yₙ.

38. The method as defined by claim 36, wherein the left R-linear map L is defined by: L(x,y)=x₁#(y₁)³+x₂#(y₂)³+ . . . +xₙ#(yₙ)³.

39. The method as defined by claim 16, wherein said encrypted message element E is produced by a user at one location, transmitted from said one location to another location, and decrypted by a user at said another location.

40. The method as defined by claim 6, wherein each said real number is represented as decimal number with a prescribed number of decimal places after the dot.

41. The method as defined by claim 40, wherein each said number is an integer.

42. A method of communicating information between users of a communication system, the method comprising the steps of:
means for generating a module V over a ring R;
means for generating an outer component P of encryption key that includes sequence (p₁, p₂, . . . , pₖ) where each member pⱼ of the sequence belongs to the set {1, 2, . . . , m};
means for generating an inner component Q of encryption key that includes elements v_{1,} v_{2,} . . . _{,} vₘ of V and automorphisms g_{1,} g_{2,} . . . _{,} gₘ of V;
means for generating the encryption key K=(P; Q), where P is the outer component and Q is the inner component; means for generating an encryption automorphism Tₑ of V based on the encryption key K, where Tₑ includes a composition of certain automorphisms T₁, T₂, . . . , Tₘ of the module V which composition is performed in the order prescribed by P;
means for generating an encrypted message element E as a function of a message element M in V and of the encryption automorphism Tₑ;
means for transmitting the encrypted message element E along with the outer component P from one user to another;
means for generating the outer component P′ of the decryption key that includes sequence (pₖ, pₖ₋₁, . . . p₁), i.e., the sequence that is reversed of that involved in producing the outer component P of the encryption key; means for generating the decryption key K′=(P′; Q′), where P′ is the outer component of the decryption key and Q′ is the inner component of the decryption key which is equal to the inner component Q of the encryption key;
means for generating a decryption automorphism T_{d} of V based on the decryption key K′, where T_{d} includes a composition of the automorphisms T₁, T₂, . . . , Tₘ, which composition is performed in the order prescribed by P′, e.g., T_{d} is the inverse automorphism of Tₑ; means for determining the message element M as a function of the encrypted message element E and of the decryption automorphism T_{d}, where the function is the same as that one used in generation of E (that is, the decryption method is symmetric to encryption: the decryption proceeds as the encryption, but with replacement of the outer component P with the outer component P′).

43. The system as defined by claim 42, wherein said encrypted message element is produced by a user at one location, transmitted from said one location to another location, and decrypted by a user at said another location.
